(19) United States
(12) Patent Application Publication
(10) Pub. No.: US 2012/0286852 A1
(43) Pub. Date: Nov. 15, 2012

(54) CHARGE-DISCHARGE DEVICE

(76) Inventor: Shuo-Chun HUNG, Taichung City (TW)

(21) Appl. No.: 13/465,479

(22) Filed: May 7, 2012

(30) Foreign Application Priority Data
May 13, 2011 (TW) 100116822

(51) Int. Cl. G05F 3/02

(52) U.S. Cl. 327/535

(57) ABSTRACT

A charge-discharge device has a current generating circuit, a charging circuit, a discharging circuit, and a signal processing circuit. The current generating circuit has a first transistor and a second transistor for generating a reference current. The charging circuit has a third transistor, coupled with the first transistor, for providing a charging current to a load according to the reference current. The discharging circuit has a fourth transistor, coupled with the second transistor, for providing a discharging current to the load according to the reference current. The signal processing circuit has a first input end coupled with the first and the second transistors, a second input end for coupling with the load, and an output end coupled with the first and the third transistors. The signal processing circuit amplifies the difference signal between the first end and the second input end to adjust the charging current and/or the discharging current.

### CROSS-REFERENCE TO RELATED APPLICATIONS

This application claims the benefit of priority to Taiwanese Patent Application No. 100116822, filed on May 13, 2011, the entirety of which is incorporated herein by reference for all purposes.

### BACKGROUND

The present disclosure generally relates to a circuit device, and more particularly, to the circuit device for providing a charging current and a discharging current to a load.

A charge-discharge device generally comprises a charging circuit and a discharging circuit, e.g., a charge-pump circuit. The architectures of the charge-discharge devices are simple and therefore widely utilized in many applications. For example, a charge-pump circuit combined with a phase detector, a loop filter, and a voltage-controlled oscillator may be utilized in a phase-locked loop circuit.

In the phase-locked loop circuit, the charge-pump circuit may be configured to provide the same charging current and discharging current. When the charging time is longer than the discharging time, the charge-pump circuit provides a charging current to the loop filter for increasing the output voltage of the loop filter, the frequency of the output signal of the voltage-controlled oscillator, and therefore the frequency of the output signal of the phase-lock loop circuit. On the other hand, when the charging time is shorter than the discharging time, the charge-pump circuit provides a discharging current to the loop filter for decreasing the output voltage of the loop filter, the frequency of the output signal of the voltage-controlled oscillator, and therefore the frequency of the output signal of the phase-lock loop circuit.

When the phase-lock loop circuit is required to provide an output signal of a fixed frequency, the charging time and the discharging time of the charge-pump circuit may be configured to be the same. Thus, the output voltage of the loop filter, the frequency of the output signal of the voltage-controlled oscillator, and therefore the frequency of the output signal of the phase-lock loop circuit may be fixed. Sometimes, even if the charging time and the discharging time are configured to be the same, the charge-pump circuit still may not generate the same charging current and discharging current because of the process variation or the mismatch in the circuit. Jitters, therefore, occur at the output of the loop filter and disturb the output signals of the voltage-controlled oscillator and the output signals of the phase-locked loop circuit. Moreover, when several charge-pump circuits are implemented in the circuit, the difference between the charging currents and the discharging currents may be accumulated. Therefore, the jitters increase and further deteriorate the system performance.

### SUMMARY

In view of the foregoing, it is appreciated that a substantial need exists for the charge-discharge devices that can reduce the difference between the charging current and the discharging current for reducing the effects of the jitters.

An embodiment of a charge-discharge device is disclosed, comprising: a current generating circuit, comprising a first transistor and a second transistor, for generating a reference current; a charging circuit, comprising a third transistor coupled with the first transistor, for providing a charging current to a load according to the reference current; a discharging circuit, comprising a fourth transistor coupled with the second transistor, for providing a discharging current to the load according to the reference current; and a signal processing circuit, comprising a first input end coupled with the first transistor and the second transistor, a second input end for coupling with the load, and an output end coupled with the first transistor and the third transistor, for amplifying a difference signal between the first input end and the second input end to generate a controlling signal for configuring at least one of the charging current and the discharging current.

Another embodiment of a charge-discharge device is disclosed, comprising: a current generating circuit, comprising a first transistor and a second transistor, for generating a reference current; a charging circuit, comprising a third transistor coupled with the first transistor, for providing a charging current to a load according to the reference current; a discharging circuit, comprising a fourth transistor coupled with the second transistor, for providing a discharging current to the load according to the reference current; and a signal processing circuit, comprising a first input end coupled with the first transistor and the second transistor, a second input end for coupling with the load, and an output end coupled with the second transistor and the fourth transistor, for amplifying a difference signal between the first input end and the second input end to generate a controlling signal for configuring at least one of the charging current and the discharging current.

Another embodiment of a charge-discharge device is disclosed, comprising: a current generating circuit, comprising a first transistor and a second transistor, for generating a reference current; a charging circuit, comprising a third transistor coupled with the first transistor, for providing a charging current to a load according to the reference current; a discharging circuit, comprising a fourth transistor coupled with the second transistor, for providing a discharging current to the load according to the reference current; a voltage adjusting circuit, comprising a first input end coupled with the load and a second input end coupled with at least one of the first transistor and the second transistor and to at least one of the third transistor and the fourth transistor, for decreasing a voltage difference between the first input end and the second input end; and a bias circuit, for providing a controlling signal to at least one of the first transistor and the second transistor and to at least one of the third transistor and the fourth transistor for conducting at least one of the first, the second, the third, and the fourth transistor.

Another embodiment of a charge-discharge device is disclosed, comprising: a current generating circuit, comprising a first transistor and a second transistor, for generating a reference current; a charging circuit, comprising a third transistor coupled with the first transistor, for providing a charging current to a load according to the reference current; a discharging circuit, comprising a fourth transistor coupled with the second transistor, for providing a discharging current to the load according to the reference current; and a signal processing circuit, comprising a first end coupled with at least one of the charging circuit and the discharging circuit, a second end coupled with the current generating circuit, and a third end coupled with at least one of the third transistor and the fourth transistor, for generating a first controlling signal at the second end according to a signal value of the first end for configuring the reference current of the current generating circuit, and for generating a second controlling signal according to the reference current for configuring at least one of the charging current and the discharging current.

It is to be understood that both the foregoing general description and the following detailed description are exemplary and explanatory only and are not restrictive of the invention, as claimed.

### BRIEF DESCRIPTION OF THE DRAWINGS

FIG. 1 shows a simplified block diagram of an example charge-discharge device;

FIG. 2 shows a simplified block diagram of another example charge-discharge device;

FIG. 3 shows a simplified block diagram of still another example charge-discharge device; and

FIG. 4 shows a simplified block diagram of the current source and the bias circuit in FIG. 3, all arranged in accordance with at least some embodiments of the present disclosure described herein.

### DETAILED DESCRIPTION

Reference will now be made in detail to embodiments of the invention, which are illustrated in the accompanying drawings. The same reference numbers may be used throughout the drawings to refer to the same or like parts or components/operations. Certain terms are used throughout the description and following claims to refer to particular components. As one skilled in the art will appreciate, vendors may refer to a component by different names. This document does not intend to distinguish between components that differ in name but not in function. In the following description and in the claims, the terms “comprise” are used in an open-ended fashion, and thus should be interpreted to mean “include, but not limited to . . . .” Also, the phrase “coupled with” is intended to compass any indirect or direct connection. Accordingly, if this document mentioned that a first device is coupled with a second device, it means that the first device may be directly or indirectly connected to the second device through an electrical connection, wireless communications, optical communications, or other signal connections with/without other intermediate devices or connection means.

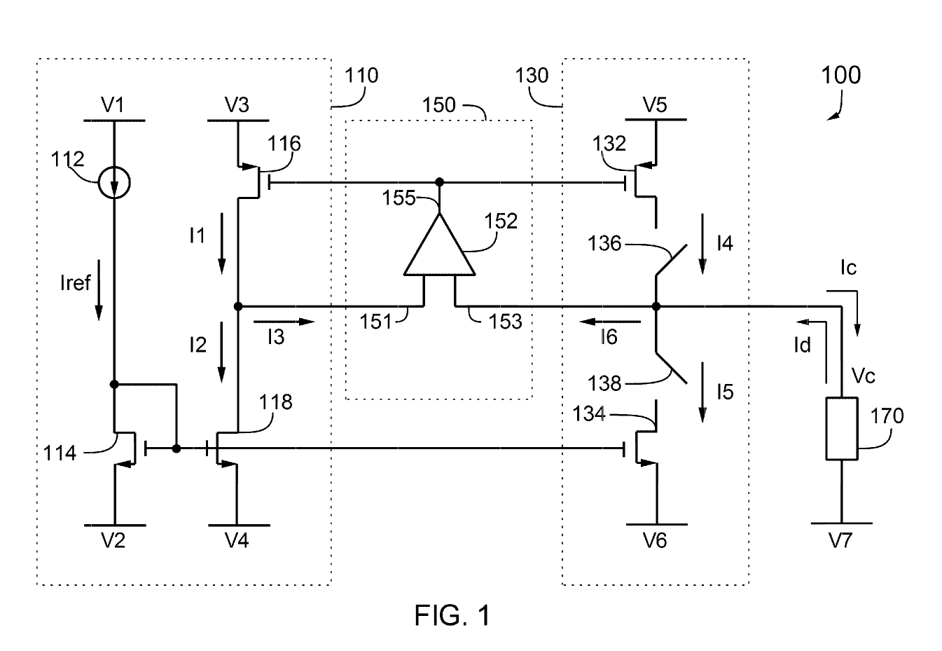

FIG. 1 shows a simplified block diagram of an example charge-discharge device 100. The charge-discharge device 100 comprises a current generating circuit 110, a charge-pump circuit 130, and a signal processing circuit 150 for providing the charging current and the discharging current to a load 170. The current generating circuit 110 comprises a current source 112 and transistors 114, 116, and 118. The charge-pump circuit 130 comprises transistors 132 and 134 and switches 136 and 138. The signal processing circuit 150 comprises an amplifier 152.

In the current generating circuit 110, one end of the current source 112 is coupled with a first voltage level V1 and the other end is coupled with a transistor 114 for providing a reference current Iref. The current source 112 may be realized with any suitable type of current source or the combination of active device(s) and/or passive device(s). In this embodiment, when the voltage of the first voltage level V1 and/or the voltage of the node between the current source 112 and the transistor 114 vary, the generated reference current of the current source 112 Iref is still fixed or only varies slightly. In another embodiment, other compensating circuits may be utilized in the current generating circuit 110 for compensating the variation of the reference current Iref. Thus, when the voltage of the first voltage level V1 and/or the voltage of the node between the current source 112 and the transistor 114 vary, the current generating circuit 110 may still generate a substantially fixed reference current. In another embodiment, the current generating circuit 110 does not comprise a compensating circuit for compensating the variation of the reference current Iref. In another embodiment, the current source 112 generates a reference current Iref, which varies with the voltage of the first voltage level V1 and/or the voltage of the node between the current source 112 and the transistor 114. Moreover, the current generating circuit 110, the charge-pump circuit 130 and/or the signal processing circuit 150 are modified accordingly.

In this embodiment, the transistor 114 and the transistor 118 are realized with n-channel field-effect transistors (N-FET), and the transistor 116 is realized with a p-channel field-effect transistor (P-FET). In another embodiment, the transistor 114, the transistor 116, and the transistor 118 may be realized respectively with any suitable type of transistor or the combination of active device(s) and/or passive device(s), e.g., the bipolar junction transistor (BJT), the FET, cascode transistors, or the circuits comprising transistors and resistors.

The source of the transistor 114 is coupled with a second voltage level V2. The drain and the gate of the transistor 114 are coupled with the current source 112. The source of the transistor 116 is coupled with a third voltage level V3. The gate of the transistor 116 is coupled with the output end 155 of the signal processing circuit 150, and the drain of the transistor 116 is coupled with the drain of the transistor 118. The source of the transistor 118 is coupled with a fourth voltage level V4, and the gate of the transistor 118 is coupled with the gate of the transistor 114.

In the charge-pump circuit 130 of this embodiment, the transistor 132 is realized with a P-FET, and the transistor 134 is realized with an N-FET. In another embodiment, the transistor 132 and the transistor 134 may be realized with any suitable type of transistor or the combination of active device(s) or passive device(s).

The source of the transistor 132 is coupled with a fifth voltage level V5. The gate of the transistor 132 is coupled with the output end 155 of the signal processing circuit 150, and the drain of the transistor 132 is coupled with the switch 136. The source of the transistor 134 is coupled with a sixth voltage level V6. The gate of the transistor 134 is coupled with the gates of the transistor 114 and the transistor 118. The drain of the transistor 134 is coupled with the switch 138.

The switches 136 and 138 are coupled with the load 170 and may be realized with any suitable combination of active device(s) and/or passive device(s). When the switch 136 is conducted and the switch 138 is not conducted, the charge-pump circuit 130 charges the load 170 with a charging current Ic through the transistor 132 and the switch 136. When the switch 136 is not conducted and the switch 138 is conducted, the charge-pump circuit 130 discharges the load 170 with a discharging current Id through the switch 138 and the transistor 134. Thus, the upper part of the charge-pump circuit is configured as the charging circuit, and the lower part is configured as the discharging circuit.

According to the signal values of the current generating circuit 110 and the charge-pump circuit 130 (e.g., currents I1˜I6, the voltage of the drain of the transistor 116, and/or the voltage Vc of the load 170), the signal processing circuit 150 generates a controlling signal at the output end 155 to adjust the current I1 flowing from the drain of the transistor 116, the current I2 flowing into the drain of the transistor 118, the current I4 flowing from the drain of the transistor 132, and/or the current I5 flowing into the drain of the transistor 134. The difference between the charging current Ic and the discharging current Id may therefore be reduced.

In another embodiment, the signal processing circuit 150 generates the controlling signal at the output end 155 according to the signal values of the charge-pump circuit 130 for adjusting the current I1 flowing from the drain of the transistor 116, and/or the current I2 flowing into the drain of the transistor 118. According to the currents I1 or I2, the signal processing circuit 150 generates the controlling signal at the output end 155 for adjusting the current I4 flowing from the drain of the transistor 132, and/or the current I5 flowing into the drain of the transistor 134. Therefore, the difference between the charging current Ic and the discharging current Id may be reduced.

In the signal processing circuit 150 of this embodiment, the amplifier 152 is a voltage-input voltage-output amplifier. The input end 151 is coupled with the drains of the transistor 116 and the transistor 118. The input end 153 is coupled with the load 170, and the output end 155 is coupled with the gates of the transistor 116 and the transistor 132.

According to the voltage difference between the input end 151 and the input end 153, the amplifier 152 generates the amplified voltage difference as the controlling signal at the output end 155 for adjusting the gate voltages of the transistor 116 and the transistor 132, the current I1 flowing from the drain of the transistor 116, and the current I4 flowing from the drain of the transistor 132. Thus, the voltage difference between the input end 151 and input end 153 may be reduced. In the ideal condition, the voltage difference between the input end 151 and the input end 153 approaches zero. In another embodiment, according to the voltage difference between the input end 151 and the input end 153, the amplifier 152 generates multiple controlling signals for respectively adjusting the gate voltages of the transistor 116 and the transistor 132, the current I1 flowing from the drain of the transistor 116, and the current I4 flowing from the drain of the transistor 132. Thus, the voltage difference between the input end 151 and input end 153 may be reduced.

In one embodiment, the amplifier 152 is an amplifier with a high gain, e.g., a high-gain operational amplifier. The non-inverting input end 151 of the amplifier 152 is coupled with the drains of the transistors 116 and 118. The inverting input end 153 of the amplifier 152 is coupled with the load 170. The amplifier 152, the transistor 132, and the switch 136 form a negative feedback loop. In this configuration, the amplifier 152 forces the voltages of the non-inverting input end 151 and the inverting input end 153 to approach zero because the two input ends of the operational amplifier are “virtual short” (one of the characteristics of the operational amplifier). The voltages of the drains of the transistors 132 and 116 may therefore be configured to be substantially the same. Moreover, to stabilize the negative feedback loop, the amplifier 152 configures the gate voltage of the transistor 132 by amplifying the small voltage difference between the non-inverting input end 151 and the inverting input end 153 with a high gain. The amplifier 152 automatically generates an optimized voltage at the gate of the transistor 132 with the negative feedback mechanism. The voltage of the gate of the transistor 132 may also be utilized as the voltage of the gate of the transistor 116. The voltages of the terminals of the transistors 116 and 132 may be configured to be substantially the same, and therefore the currents I2 and I4 may be substantially the same. Moreover, the charging current Ic and the discharging current Id may be substantially the same.

The amplifier 150 usually operates within a predetermined range of the input voltage. Thus, in the embodiment of FIG. 1, when the voltage of the input end 151 and/or the voltage of the input end 153 of the amplifier 150 locate in the predetermined range, the voltage difference between the input end 151 and the input end 153 may approach zero. When the voltage of the input end 151 and/or the voltage of the input end 153 of the amplifier 150 do not locate in the predetermined range, the voltage difference between the input end 151 and the input end 153 may still exist.

In another embodiment, the signal processing circuit 150 may be a current-input current-output amplifier, a current-input voltage-output amplifier, a voltage-input current-output amplifier, or an amplifier with current/voltage input(s) and/or current/voltage output(s). The amplifier 150 may collaborate with other circuits for adjusting the gate voltages and the currents I1 and I4 flowing from the drains of the transistors 116 and 132.

In this embodiment, the dimensions of the transistors 114, 116, 118, 132, and 134 may be configured for generating substantially the same charging current and discharging current. For example, the transistors 114, 116, 118, 132, and 134 may be configured to have substantially the same oxide thickness and the same width to length ratio. In another embodiment, the dimensions of the transistors 114, 116, 118, 132, and 134, e.g., the oxide thickness and the width to length ratio of the transistor, may be properly configured so that the charge-discharge device 100 may generate substantially the same charging current and discharging current. For example, the channel lengths of the transistors 116, 118, 132, and 134 may be configured to be substantially the same, and the channel widths of the transistors 116, 118, 132, and/or 134 may be configured to be multiples or a portion of the channel width of the transistor 114. Therefore, the current I1 flowing from the drain of the transistor 116, the current I2 flowing into the drain of the transistor 118, the current I4 flowing from the drain of the transistor 132, and/or the current I5 flowing into the drain of the transistor 134 may be configured to be multiples or a portion of the reference current Iref, respectively.

In this embodiment, the first voltage level V1, the third voltage level V3, and the fifth voltage level V5 are configured to be substantially the same, e.g., coupled with a three-volt voltage source, VDD. The second voltage level V2, the fourth voltage level V4, the sixth voltage level V6, and a seventh voltage level V7 are also configured to be substantially the same, e.g., coupled with the ground. In another embodiment, the voltage levels V1˜V7 may be respectively configured as substantially the same voltage value or different voltage values according to the architectures of the current generating circuit 110, the charge-pump circuit 130, the signal processing circuit 150, and/or other circuits.

In this embodiment, the current I2 flowing into the drain of the transistor 118 of the current generating circuit 110 is equal to the reference current Iref. In the ideal condition, the current I3 flowing into the input end 151 of the amplifier 152 is zero or negligible. Thus, the current I1 flowing from the drain of the transistor 118 is substantially equal to the current I2 flowing into the drain of the transistor 118.

When the switch 136 is conducted and the switch 138 is not conducted, the charge-discharge device 100 charges the load 170 with the charging current Ic. In the ideal condition, the value of the current I6 flowing into the input end 153 of the amplifier 152 is zero or negligible. Therefore, the charging current Ic flowing from the charge-pump circuit 130 to the load 170, is substantially equal to the current I4 flowing from the drain of the transistor 132.

When the switch 136 is not conducted and the switch 138 is conducted, the charge-discharge device 100 discharges the load 170 with the discharging current Id. In the ideal condition, the value of the current I6 flowing into the input end 153 of the amplifier 152 is zero or negligible. Therefore, the discharging current Id flowing from the load 170 to the charge-pump circuit 130 is substantially equal to the current I5 flowing into the drain of the transistor 134.

Because the third voltage level V3 coupled with the source of the transistor 116 is equal to the fifth voltage level V5 coupled with the source of the transistor 132, the gates of the transistors 116 and 132 are biased with substantially the same voltage when the charge-discharge device 100 provides the charging current Ic to the load 170. Moreover, the voltage of the drain of the transistor 116 coupled with the input end 151 is substantially equal to the voltage of the drain of the transistor 132 coupled with the input end 153. Therefore, the current I4 flowing from the drain of the transistor 132 is substantially equal to the current I1 flowing from the drain of the transistor 116. The charging current Ic flowing from the charge-pump circuit 130 to the load 170 is substantially equal to the current I4 and the current I1, which flow from the drain of the transistors 132 and 116, respectively.

Because the fourth voltage level V4 coupled with the source of the transistor 118 is equal to the sixth voltage level V6 coupled with the source of the transistor 134, the gates of the transistors 118 and 134 are biased at substantially the same voltage when the charge-discharge device 100 provides the discharging current Id to the load 170. The voltage of the drain of the transistor 118 coupled with the input end 151 is substantially equal to the voltage of the drain of the transistor 134 coupled with the input end 153. Therefore, the current I5 flowing into the drain of the transistor 134 is substantially equal to the current I2 flowing into the drain of the transistor 118. The discharging current Id flowing from the load 170 to the charge-pump circuit 130 is substantially equal to the current I5 and the current I2, which flow into the drain of the transistors 134 and 118, respectively.

The charging current Ic flowing from the charge-pump circuit 130 to the load 170 is substantially equal to the current I1 flowing from the drain of the transistor 116. The discharging current Id flowing from the load 170 to the charge-pump circuit 130 is substantially equal to the current I2 flowing into the drain of the transistor 118. The current I1 flowing from the drain of the transistor 116 is substantially equal to the current I2 flowing into the drain of the transistor 118. Therefore, the charging current Ic and the discharging current Id are substantially the same in the charge-discharge device 100.

In short, in this embodiment, the reference current Iref generated from the current source 112 of the current generating circuit 110 is configured as the reference current for other circuits. The current I2 flowing into the drain of the transistor 118 equals or substantially equals the reference current Iref by utilizing the current mirror. The current I3 is negligible or zero in the ideal condition. The current I1 is equal to I2, and therefore equal to the reference current Iref. When the charge-discharge device 100 provides the discharging current Id, the voltages of terminals of the transistor 118 are substantially equal to the voltages of the terminals of the transistor 134, respectively. The current I5 is equal to the current I2, and the discharging current Id (i.e., the current I5 flowing into the drain of the transistor 134) is equal to the reference current Iref. When the charge-discharge device 100 provides the charging current, the voltages of terminals of the transistor 116 are substantially equal to the voltages of the terminals of the transistor 132, respectively. The current I4 is equal to the current I1, and the charging current Ic (i.e., the current I4 flowing from the drain of the transistor 132) is equal to the reference current Iref. The charging current Ic and the discharging current Id of the charge-discharge device 100 may therefore configured to be the same.

If the voltage Vc of the load 170 varies, the voltages of the input ends 151 and 153 may be different for a certain duration of time. When the charge-discharge device 100 provides the charging current Ic to the load 170, the amplifier 152 generates the controlling signals at the output end 155 by amplifying the voltage difference between the input ends 151 and 153. The controlling signals are transmitted to the gates of the transistors 116 and 132 for adjusting the current I1 and the current I4, which flow from the drain of the transistors 116 and 132, respectively. When the charge-discharge device 100 discharges the load 170 with the discharging current Id, the amplifier 152 generates the controlling signals at the output end 155 by amplifying the voltage difference between the input ends 151 and 153. The controlling signals are transmitted to the gate of the transistor 116 for adjusting the current I1 flowing from the drain of the transistor 116. The current I2 and I5 flowing into the transistors 118 and 134 are adjusted accordingly. Thus, the difference between the current I4 flowing from the drain of the transistor 132 and the current I5 flowing into the drain of the transistor 134 may be reduced, and therefore the difference between the charging current Ic and the discharging current Id may be reduced.

In another embodiment, the amplifier 152 of the signal processing circuit 150 may be realized with a current-input amplifier. The currents flowing into the input ends 151 and 153 are not zero. Therefore, the width to length ratios of the transistors 116, 118, 132, and 134, respectively or in combination of other circuits, may be modified accordingly for reducing the difference between the charging current Ic and the discharging current Id of the charge-discharge device 100.

In another embodiment, the output end 155 of the amplifier 152 is coupled with the gates of transistors 118 and 134 for reducing the difference between the charging current Ic and the discharging current Id of the charge-discharge device 100. Other circuits may be modified accordingly, if necessary.

In another embodiment, the voltage difference between the input end 151 and the input end 153 of the amplifier 152 is amplified and combined with a predetermined voltage. The combined signal may be used to configure the gate voltages and the drain currents I1 and I4 of the transistors 116 and 132, and/or the combined signal may be used to configure the gate voltages and the drain currents I2 and I5 of the transistors 118 and 134.

In another embodiment, the gain of the amplifier is configured to be equal to or greater than 2. In some preferred embodiments, the gain of the amplifier is configured to be equal to or greater than 10.

In another embodiment, the amplifier 152 may be realized with multiple amplifiers. In still another embodiment, the voltage buffer(s) and/or the current buffer(s) may be configured between the input end 153 of the amplifier 152 and the load 170 for stabilizing the system. The voltage buffer(s) and/or the current buffer(s) may be realized with the combination of active device(s) and/or passive device(s), e.g., a voltage follower or a current follower comprising one or more amplifiers.

In the foregoing embodiments, the output end 155 of the amplifier 152 is coupled with the controlling end of the transistor (e.g., the gate of the FET or the base of the BJT) of the current generating circuit 110 and/or the charge-pump circuit 130 for adjusting the charging current Ic and the discharging current Id of the charge-pump circuit 130. In another embodiment, the output end 155 of the amplifier 152 is coupled with the drains, the sources and/or the gates of the transistors of the current generating circuit 110 and/or the charge-pump circuit 130 for adjusting the charging current Ic and the discharging current Id of the charge-pump circuit 130.

In further another embodiment, the charge-discharge device 100 comprises multiple current generating circuits for providing the reference currents to the charging circuit and the discharging circuit of the charge-pump circuit 130, respectively. One or more amplifiers may be utilized in the signal processing circuit 150 for adjusting the currents of the charging circuit and the discharging circuit of the charge-pump circuit 130 according to the amplified voltage differences of the input ends of the amplifiers. Therefore, the difference between the charging current Ic and the discharging current Id of the charge-discharge device 100 may be reduced.

The current generating circuit 110, the charge-pump circuit 130, and the signal processing circuit 150, respectively or in combination, may be realized with suitable architectures. For example, the Wilson current mirror, the gain boosted current mirror, and/or the cascode current mirror may be utilized in the current generating circuit and/or the charge-pump circuit

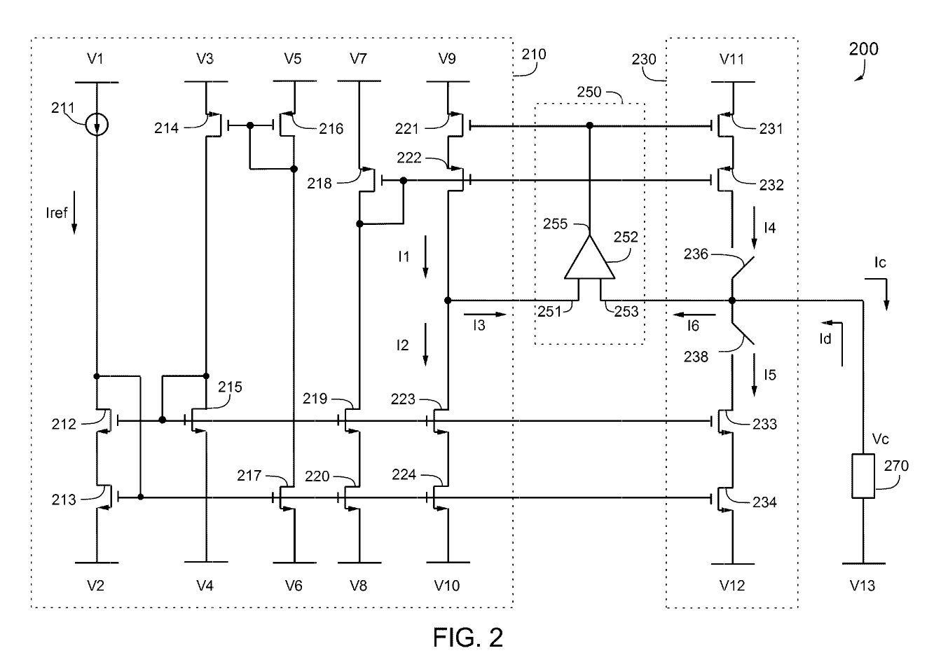

FIG. 2 shows a simplified block diagram of another example charge-discharge device 200. The charge-discharge device 200 comprises a current generating circuit 210, a charge-pump circuit 230, and a signal processing circuit 250 for providing a charging current Ic and a discharging current Id to a load 270. The current generating circuit 210 comprises a current source 211 and transistors 212˜224. The charge-pump circuit 230 comprises transistors 231˜234 and switches 236 and 238. The signal processing circuit 250 comprises an amplifier 252 with input ends 251 and 253, and an output end 255.

The operation of the charge-discharge device 200 is similar to the charge-discharge device 100 in FIG. 1. The current generating circuit 210 generates a reference current. The charge-pump circuit 230 provides a charging current Ic and a discharging current Id to the load 270. The signal processing 250 amplifies the difference signal between the input end 251 and the input end 253 for adjusting the charging current Ic and the discharging current Id of the charge-pump 230. Therefore, the difference between the charging current Ic and the discharging Id may be reduced.

Compared with the charge-discharge device 100, additional circuits are utilized in the charge-discharge device 200 for providing the stabilized output current. For example, the cascode current mirrors are adopted in the current generating circuit 210 and the charge-pump 230 for reducing the channel length modulation effect and providing stable output currents. Thus, the difference between the charging current Ic and the discharging current Id of the charge-discharge device 200 may be further reduced.

The voltage levels V1˜V13 may be configured as the same voltage or different voltage(s) respectively. The width to length ratios of the transistors may also be adjusted according to different design considerations. Moreover, the charge-discharge device 200 may be combined with the foregoing embodiments for reducing the difference between the charging current Ic and the discharging current Id.

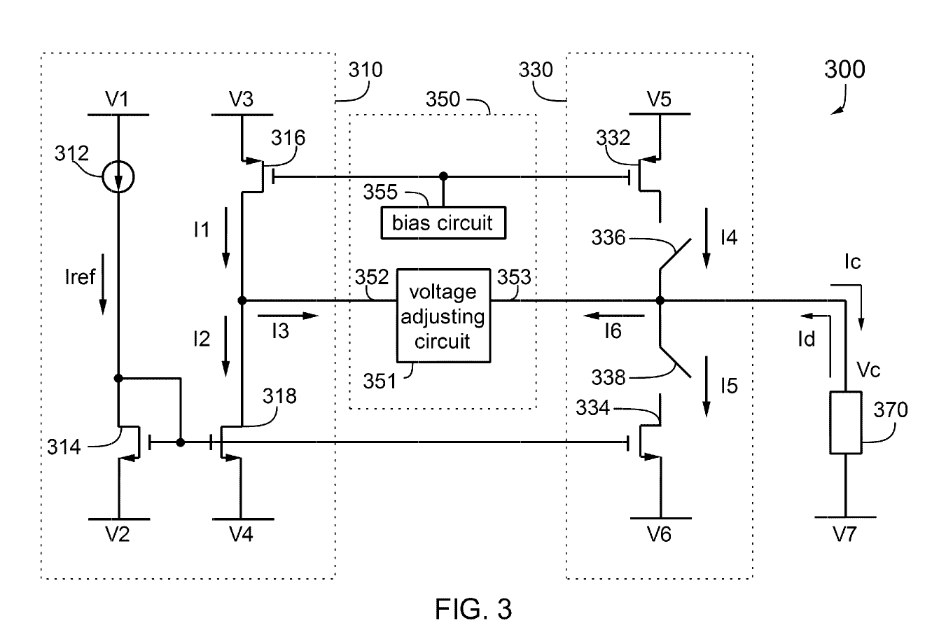

FIG. 3 shows a simplified block diagram of another example charge-discharge device 300. The charge-discharge device 300 comprises a current generating circuit 310, a charge-pump circuit 330, and a signal processing circuit 350 for providing the charging current Ic and the discharging current Id to a load 370. The current generating circuit 310 comprises a current source 312 and transistors 314,316 and 318. The charge-pump circuit 330 comprises transistors 332 and 334 and switches 336 and 338. In this embodiment, the current generating circuit 310 and the charge-pump circuit 330 are configured to have the same architectures as the current generating circuit 110 and the charge-pump circuit 130 in FIG. 1, and the operation of these circuits may be referred to the corresponding description above.

The signal processing circuit 350 comprises a voltage adjusting circuit 351 and a bias circuit 355. The voltage adjusting circuit 351 may be coupled directly between an end 352 and an end 353 and realized with the voltage buffer(s) or other active device(s) and/or passive device(s). The voltage adjusting circuit 351 is configured to reduce or eliminate the voltage difference between the ends 352 and 353. Moreover, the current flowing between the end 352 and the end 353 may be blocked so that the currents I3 and I6 are zero or negligible.

The bias circuit 355 may be realized with the combination of active device(s) and/or passive device(s) for generating a fixed voltage or a variable voltage for conducting the transistor 316 and/or the transistor 332 in the saturation region or the linear region. In one embodiment, the bias circuit 355 may change the output voltage according the voltage Vc of the load 370 for adjusting the gate voltages of the transistor 316 and the transistor 332 and the currents I1 and I4 flowing from the drains of the transistor 316 and the transistor 332. Therefore, the difference between the charging current Ic and the discharging current Id may be reduced.

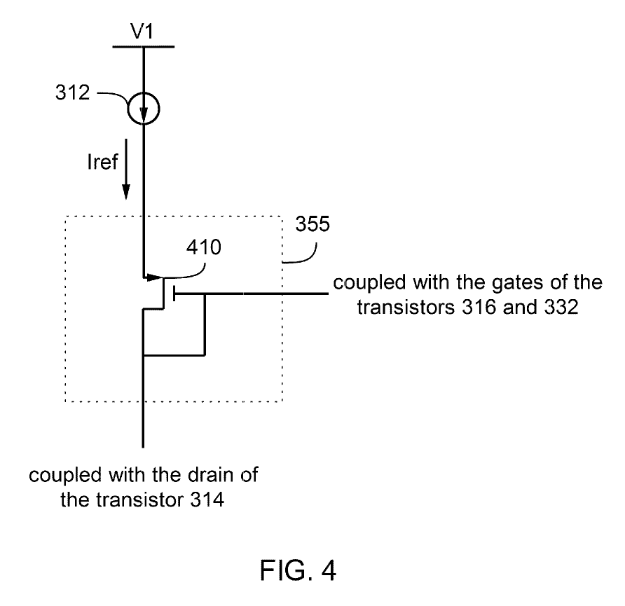

In another embodiment, the bias circuit 355 may also be combined with the current generating circuit 310 for adjusting the gate voltages of the transistor 316 and the transistor 332 and the currents I1 and I4 flowing from the drains of the transistor 316 and the transistor 332, respectively. Therefore, the difference between the charging current Ic and the discharging current Id may be reduced. For example, FIG. 4 shows a simplified block diagram of the current source 312 and the bias circuit 355 of the embodiment in FIG. 3. The bias circuit 355 comprises a transistor 410. The source of the transistor 410 is coupled with the current source 312. The gate and the drain of the transistor 410 are coupled with the gates of the transistors 316 and 332. The drain of the transistor 314 in FIG. 3 is modified to be coupled with the drain of the transistor 410. In this embodiment, the third voltage level V3 coupled with the source of the transistor 316 and the fifth voltage level V5 coupled with the source of the transistor 332 are configured to be substantially the same, e.g., coupled with a three-volt voltage source, Vdd. The fourth voltage level V4 coupled with the source of the transistor 318 and the sixth voltage level V6 coupled with the source of the transistor 334 are configured as substantially the same, e.g., coupled with the ground. The voltage difference between the two ends 352 and 353 of the voltage adjusting circuit 351 may be reduced. The gate voltages of the transistors 410, 314, 316, 318, 332, and 334 are configured to be substantially the same. Therefore, the difference between the charging current Ic and the discharging current Id may be reduced.

In the description and drawings, the numbers, the locations, and the connections of the components are illustrative only. Other circuits, components, and connections may be omitted in the drawings. People of ordinary skill in the art may appreciate that each component may be realized with one or more component(s) and the function of the multiple components may be realized by a single component. People of ordinary skill in the art may appreciate that signals, devices, circuits, or operations in the description or drawings may be, respectively or collective, characterized in the voltage form or in the current form without departing from the spirit of the invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A charge-discharge device, comprising:
a current generating circuit, comprising a first transistor and a second transistor, for generating a reference current;
a charging circuit, comprising a third transistor coupled with the first transistor, for providing a charging current to a load according to the reference current;
a discharging circuit, comprising a fourth transistor coupled with the second transistor, for providing a discharging current to the load according to the reference current; and
a signal processing circuit, comprising a first input end coupled with the first transistor and the second transistor, a second input end for coupling with the load, and an output end coupled with the first transistor and the third transistor, for amplifying a difference signal between the first input end and the second input end to generate a controlling signal for configuring at least one of the charging current and the discharging current.

2. The charge-discharge device of claim 1, wherein the signal processing circuit combines the controlling signal with a predetermined voltage or a predetermined current for configuring at least one of the charging current and the discharging current.

3. The charge-discharge device of claim 1, wherein the controlling signal of the signal processing circuit configures at least one of the input current and the output current of the first transistor and/or the third transistor for configuring at least one of the charging current and the discharging current.

4. The charge-discharge device of claim 1, wherein the controlling signal of the signal processing circuit configures at least one of the input current and the output current of the first transistor, the second transistor, and the fourth transistor for configuring at least one of the charging current and the discharging current.

5. The charge-discharge device of claim 1, wherein the controlling signal is at least two times the difference signal.

6. The charge-discharge device of claim 1, further comprising:
a voltage buffer or a current buffer, coupled between the second input end of the signal processing circuit and the load.

7. A charge-discharge device, comprising:
a current generating circuit, comprising a first transistor and a second transistor, for generating a reference current;
a charging circuit, comprising a third transistor coupled with the first transistor, for providing a charging current to a load according to the reference current;
a discharging circuit, comprising a fourth transistor coupled with the second transistor, for providing a discharging current to the load according to the reference current; and
a signal processing circuit, comprising a first input end coupled with the first transistor and the second transistor, a second input end for coupling with the load, and an output end coupled with the second transistor and the fourth transistor, for amplifying a difference signal between the first input end and the second input end to generate a controlling signal for at least one of configuring the charging current and the discharging current.

8. The charge-discharge device of claim 7, wherein the signal processing circuit combines the controlling signal with a predetermined voltage or a predetermined current for configuring at least one of the charging current and the discharging current.

9. The charge-discharge device of claim 7, wherein the controlling signal of the signal processing circuit configures at least one of the input current and the output current of the second transistor and/or the fourth transistor for configuring at least one of the charging current and the discharging current.

10. The charge-discharge device of claim 7, wherein the controlling signal of the signal processing circuit configures at least one of the input current and the output current of the first, the second and the third transistors for configuring at least one of the charging current and the discharging current.

11. The charge-discharge device of claim 7, wherein the controlling signal is at least two times the difference signal.

12. The charge-discharge device of claim 7, further comprising:
a voltage buffer or a current buffer, coupled between the second input end of the signal processing circuit and the load.

13. A charge-discharge device, comprising:
a current generating circuit, comprising a first transistor and a second transistor, for generating a reference current;
a charging circuit, comprising a third transistor coupled with the first transistor, for providing a charging current to a load according to the reference current;
a discharging circuit, comprising a fourth transistor coupled with the second transistor, for providing a discharging current to the load according to the reference current;
a voltage adjusting circuit, comprising a first input end coupled with the load and a second input end coupled with at least one of the first transistor and the second transistor and to at least one of the third transistor and the fourth transistor, for decreasing a voltage difference between the first input end and the second input end; and
a bias circuit, for providing a controlling signal to at least one of the first transistor and the second transistor and to at least one of the third transistor and the fourth transistor for conducting at least one of the first, the second, the third, and the fourth transistors.

14. The charge-discharge device of claim 13, wherein the bias circuit configures at least one of the input current and the output current of the first transistor and/or the third transistor with the controlling signal for configuring at least one of the charging current and the discharging current.

15. The charge-discharge device of claim 13, wherein the bias circuit configures at least one of the input current and the output current of the second transistor and/or the fourth transistor with the controlling signal for configuring at least one of the charging current and the discharging current.

16. The charge-discharge device of claim 14, wherein the bias circuit combines the controlling signal with a predetermined voltage or a predetermined current for configuring at least one of the charging current and the discharging current.

17. The charge-discharge device of claim 13, wherein the bias circuit generates the controlling signal according to a voltage value of the load.

18. A charge-discharge device, comprising:
a current generating circuit, comprising a first transistor and a second transistor, for generating a reference current;
a charging circuit, comprising a third transistor coupled with the first transistor, for providing a charging current to a load according to the reference current;
a discharging circuit, comprising a fourth transistor coupled with the second transistor, for providing a discharging current to the load according to the reference current; and
a signal processing circuit, comprising a first end coupled with at least one of the charging circuit and the discharging circuit, a second end coupled with the current generating circuit, and a third end coupled with at least one of the third transistor and the fourth transistor, for generating a first controlling signal at the second end according to a signal value of the first end for configuring the reference current of the current generating circuit, and for generating a second controlling signal according to the reference current for configuring at least one of the charging current and the discharging current.

19. The charge-discharge device of claim 18, wherein the signal processing circuit combines the first and the second controlling signals with a predetermined voltage or a predetermined current for configuring at least one of the charging current and the discharging current.

20. The charge-discharge device of claim 18, wherein the signal processing circuit configures at least one of the input current and the output current of the first transistor and/or the second transistor according to the first controlling signal for configuring at least one of the charging current and the discharging current.

21. The charge-discharge device of claim 18, wherein the signal processing circuit configures at least one of the input current and the output current of the third transistor and/or the fourth transistor according to the second controlling signal for configuring at least one of the charging current and the discharging current.

22. The charge-discharge device of claim 18, wherein the controlling signal is at least two times the difference signal.

23. The charge-discharge device of claim 18, further comprising:
a voltage buffer or a current buffer, coupled between the second input end of the signal processing circuit and the load.
